(19) United States
(12) Patent Application Publication
(10) Pub. No.: US 2011/0233251 A1
(43) Pub. Date: Sep. 29, 2011

(54) ACCESSORY HOLDER SYSTEM FOR MOUNTING TO A CUP HOLDER

(76) Inventor: Thomas Steven Doig, West Bend, WI (US)

(21) Appl. No.: 13/073,920

(22) Filed: Mar. 28, 2011

Related U.S. Application Data
(60) Provisional application No. 61/341,132, filed on Mar. 29, 2010.

(51) Int. Cl. B60R 11/00

(52) U.S. Cl. 224/567

(57) ABSTRACT

An accessory holder system for mounting to a cup holder is provided. The system includes an accessory holder and a mount that is attached to the accessory holder and that may be installed in a tool-less manner into a cup holder, such that the mount grips the cup holder with enough force to be usable in highly dynamic applications. The mount includes an arm that may be a component of a scissors link and that pushes a pad against an inner surface of the cup holder to lock the mount in the cup holder.

### CROSS-REFERENCE TO RELATED APPLICATIONS

This application claims priority from U.S. Provisional Patent Application Ser. No. 61/341,132, filed on Mar. 29, 2010, the entirety of which is expressly incorporated by reference herein.

### BACKGROUND OF THE INVENTION

1. Field of the Invention

The invention relates to accessory holders for holding personal electronics and other articles and, more particularly, to accessory holders that mount to cup holders.

2. Discussion of the Related Art

Accessory holders, for holding personal electronics and/or other articles, are known. Accessory holders for are typically either heavy-duty for holding laptops and/or other large and heavy accessories, or light-duty for holding cellular telephones, global positioning system (GPS) units, and/or other small and light accessories.

Heavy-duty accessory holders typically require fasteners to mount brackets to the mounting substrate. For example, heavy-duty accessory holders that are used in vehicles use fasteners and brackets that attach to the vehicles and to which the rest of the accessory holders are attached. These fastener mounted brackets require permanently altering the vehicle by, for example, drilling holes into a dashboard, console, or other body or interior component of the vehicle and into which the fasteners are installed.

Light-duty accessory holders that do not require fasteners include bag-type mounts, suction cup mounts, and cup holder mounts. Many of these light-duty accessory holders are used in vehicles. Bag-type mounts include sand bags and bean bags that sit on dashboards and remain in place by the frictional engagement of the bag and the dashboard. Suction cup mounts use suction cups to attach light-duty accessory holders to windshields, side windows, or other surfaces that are sufficiently smooth to allow the suction cups to seal. Cup holder mounts insert into and engage the inner surfaces of vehicle cup holders.

### SUMMARY AND OBJECTS OF THE INVENTION

The inventor has recognized that fasteners requiring heavy-duty accessory holders may not be usable with many mounting substrates, because the fasteners can damage or permanently alter such substrates. As one example relating to vehicles, fleet and/or leased vehicles because the vehicle user that would benefit from the accessory holder is not the owner of the vehicle and therefore may not have permission to permanently alter the vehicle. The inventor has further recognized that fasteners requiring heavy-duty accessory holders can be difficult and require tools to install and cannot be readily moved to another vehicle.

The inventor has further recognized that bag-type mounts, suction cup mounts, and cup holder mounts are not suitable for highly dynamic applications in which the vehicles may experience substantial amounts of dynamic vehicle movements during use. Those highly dynamic applications include use on boats and various off-highway or off-road vehicles, which include sit-on and side-by-side ATVs (all-terrain-vehicles), military vehicles, and fire and other rescue vehicles. For example, the inventor has recognized that bag-type mounts are generally unable to support large accessories and their ability to maintain lateral stability may be limited as a function of the weight of the bag itself, the weight of the accessory, the surface areas of the interfaces between the accessory and the bag and the supporting structure and the bag, and the coefficient(s) of friction defined between the accessory and the bag and supporting structure and the bag. The inventor has further recognized that suction cup mounts may be adversely influenced by temperature and humidity fluctuations and rapid changes of vehicle position or orientation because the loads are typically cantilevered from or otherwise may apply a bending moment to the suction cup.

The inventor has recognized that cup holder mounts are small in size and provide only small amounts of gripping force against the cup holders, which may be inadequate to either support large accessories or to be suitable for highly dynamic applications. The inventor has further recognized that vehicle and/or other cup holders are typically not perfectly cylindrical and that known cup holder mounts may apply different gripping forces to different parts of their interface with the cup holder. The inventor has recognized that this may lead to only a small percentage of the surface area of the cup holder mount that is providing the actual gripping or holding force. The inventor has further recognized that in highly dynamic applications, the cup holders themselves may bend or flex which can compromise the integrity of the gripping action between the cup holder mount and the cup holder in which it is mounted.

According to one aspect of the invention, an accessory holder system is provided that includes an accessory holder that can selectively hold an accessory and a mount attached to the accessory holder and removably attaching the accessory holder to a vehicle and/or other cup holder, without requiring the use of tools. The cup holder may be one that is incorporated into a land or off-road vehicle, boat, plane, stroller, hot-tub, floating pool accessory, chair or other piece of furniture, tray, or other supporting surface in which a cup holder is installed. The accessory holder may be at least one of a cellular telephone holder, a global positioning system (GPS) device holder, a laptop computer holder, a food tray, a multiple drink holder, a writing pad holder, and a portable heater holder, to name a few non-limiting examples. The mount may include a scissors link having an outer portion that is transversely movable toward and away from a middle of the mount and a pad that is attached to and moves in unison with the outer portion of the scissors link for engaging and disengaging the vehicle or other cup holder. The scissors link may be able to push the pad against an inner surface of the cup holder with enough force to maintain the accessory holder in a substantially constant position while being used in highly dynamic applications and/or while holding large and heavy accessories.

According to another aspect of the invention, multiple scissors links are provided that are spaced from each other about a perimeter of the mount and to which multiple cup holder engaging pads are mounted. Each of the scissor links may have a pair of arms with corresponding ends that are spaced from each other and movable in a longitudinal direction with respect to the mount. Each of the scissor links may also have second ends that attach to each other and the respective pad. Movement of the first ends of each of the pair of arms in the longitudinal direction is translated to movement of the second ends of each of the pair of arms in a transverse direction with respect to the mount. This may push the pad of each of the scissors links against an inner surface of the cup holder so that the mount sufficiently grips the cup holder with enough force to maintain the accessory holder in a substantially constant position while being used in highly dynamic applications and/or while holding large and heavy accessories.

According to another aspect of the invention, the mount includes a stem that extends in a longitudinal direction and upper and lower collars that connect the scissors link(s) to the stem so that the upper and lower collars are movable along at least part of the length of the stem. When the upper and lower collars move toward and away from each other, they articulate the scissors link so that the pad moves away from and toward the stem, respectively. The upper collar and an upper portion of the stem may have engaging threads that define a first thread orientation, and the lower collar and a lower portion of the stem may have engaging threads that define a second, opposite thread orientation. This may allow the stem or collars to rotate (i) in a first direction to advance the collars along the threads so that they move away from each other, and (ii) in a second direction to regress the collars along the threads so that they move toward each other. This may provide a robust configuration to provide a large amount of movement of the pads that can withstand large loads that may be imposed during dynamic applications and/or while holding large and heavy accessories.

According to another aspect of the invention, the mount includes a plate at its upper end and to which the accessory holder is removably attached, allowing interchangeability of multiple accessory holders. The plate may be attached to the stem so that they rotate in unison with each other. This allows the plate to be rotated which forces the collars to move toward or away from each other along the stem and thus to force the pads toward or away from the inner surface(s) of the vehicle or other cup holder. The plate may be sized to allow the pads to tightly engage the vehicle or other cup holder with a small amount of twisting effort from the user. This may allow the user to install the mount in the cup holder without any tools and while establishing a gripping force that is strong enough to withstand large loads that may be imposed during dynamic applications and/or while holding large and heavy accessories.

According to another aspect of the invention, the pad is attached to the scissors link by way of a pivot. The pivot may be provided at a joint defined between the second ends of the arms and the pad. The pivot may define a pivot axis that is orthogonal with respect to a length of the mount so that (i) an upper end of the pad can pivot toward and away from an upper end of the mount, and (ii) a lower end of the pad can pivot toward and away from a lower end of the mount. Multiple pivots may be provided to attach multiple pads to multiple scissor links. The pivot(s) may allow the pad(s) to pivot so as to conform to a configuration of the vehicle or other cup holder, including a cup holder that has an inside diameter that differs at different portions of the cup holder. This may help accommodate installing the mount in different cup holders having different configurations. This may also provide a larger surface area of the interface between the mount and the cup holder and may equilibrize applications of force(s) across the surface area of the pad(s), providing a gripping force equilibrium within and between the pads. The gripping force equilibrium may ensure that the mount suitably pushes against all engaged portions of the inner surface of the cup holder which may enhance the rigidity of the cup holder itself and which may also help maintain the gripping engagement between the cup holder mount and the cup holder. This may allow the mount to withstand large loads that may be imposed during dynamic applications and/or while holding large and heavy accessories.

Other features and advantages of the invention will become apparent to those skilled in the art from the following detailed description and accompanying drawings. It should be understood, however, that the detailed description and specific examples, while indicating the preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a partially exploded pictorial view of an accessory holder system of the present invention;

FIG. 2 is an exploded view of the mount of the accessory holder system of FIG. 1;

FIG. 3 is a side elevation of the mount of the accessory holder system of FIG. 1 with the pads in a retracted position(s);

FIG. 4 is a side elevation of the mount of the accessory holder system of FIG. 1 with the pads in an extended position(s);

FIG. 5 is a top-plan view of the mount of the accessory holder system of FIG. 1 with the pads in a retracted position(s);and

FIG. 6 is a top-plan view of the mount of the accessory holder system of FIG. 1 with the pads in an extended position(s).

### DETAILED DESCRIPTION OF THE INVENTION

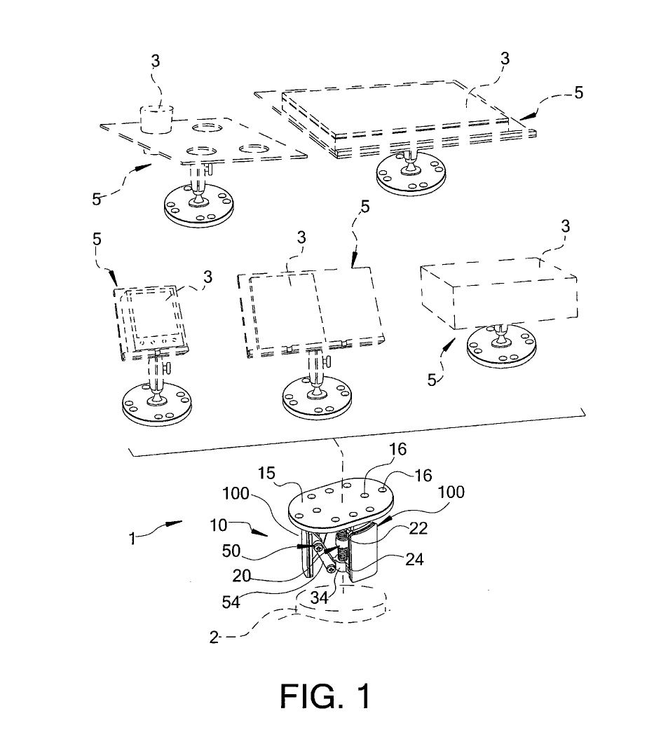

FIG. 1 illustrates an accessory holder system 1 of the present invention that can be used with a vehicle or other cup holder 2 to hold an accessory 3 from the vehicle or other cup holder 2. The system 1 is usable in highly dynamic applications so that it is suitable for use with a variety of vehicles, including road vehicles, boats, and also various off-highway or off-road vehicles, such as, for example, sit-on and side-by-side ATVs (all-terrain-vehicles), military vehicles, and off-road fire and other rescue vehicles, lawn mowers, tractors, planes, and/or other vehicles that have recessed or other suitable cup holders 2. System 1 is also useable with non-vehicle cup holders 2, including but not limited to cup holders 2 that are provided in strollers, hot-tubs, floating pool accessories, chairs or other pieces of furniture, trays, or other supporting surfaces in which cup holders 2 are installed and which may include yet other suitably sized, e.g., round or other openings that can receive respective portions of the system 1 to facilitate and accommodate its use.

Still referring to FIG. 1, system 1 includes accessory holder 5 that holds the accessory 3 and mount 10 that is attached to the accessory holder 5 and is removably and, in a tool-less manner, connected to the cup holder 2. Accessory 3 includes any of various personal electronics and/or other articles or products that are used in vehicles, including, for example, small items such as cellular telephones, GPS devices, food items, beverage containers, writing pads, and large items such as laptop computers, portable heaters, and others. Accessory holder 5 is configured to hold the respective accessory 3, whereby it includes a cellular telephone holder, GPS device holder, food tray or holder, beverage(s) holder, writing pad holder, laptop computer holder, and portable heater holder. Accessory holder 5 includes a holding mechanism that can support the accessory 3 and a rigid, telescoping, or multi-position boom, depending on the desired end-use configuration, that extends toward and couples with a mount 10 of the system 1

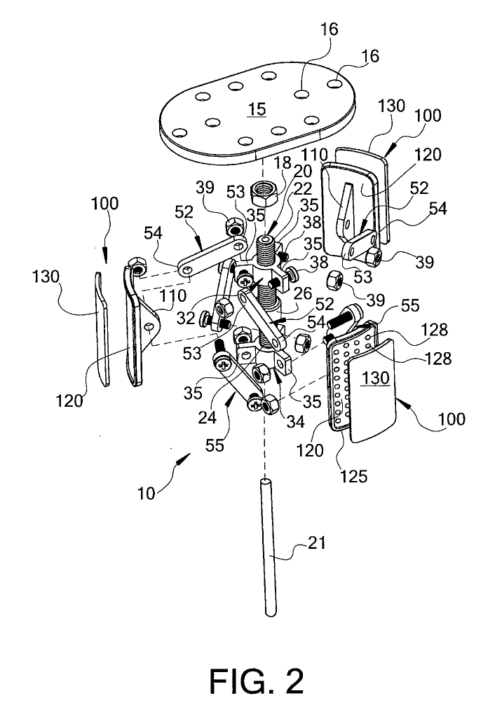

Referring now to FIGS. 1 and 2, mount 10 is configured to nest inside of the cup holder 2 and engage an inner surface(s) of the cup holder with pads 100 with sufficient gripping force(s) so as to maintain the engagement of the mount 10 in cup holder 2 and maintain the accessory holder 5 in a substantially constant position while being used in highly dynamic applications and/or while holding large and heavy accessories. Mount 10 includes plate 15 that has multiple holes 16 for accepting hardware to interchangeably connect the accessory holder 5 to the plate 15. In this embodiment, the plate has a threaded bore (not labeled) extending into its bottom surface and a jamb nut 18 (FIG. 2) locks an upper end of a stem 20 into the treaded bore of the plate 15. This locks the plate 15 and stem 20 together so that they rotate in unison with each other.

Stem 20 extends downwardly from the bottom surface of plate 15, defining an overall height of the mount 10 as being about three and one-half inches. Stem 20 includes a threaded upper portion 22 and a threaded lower portion 24. Upper and lower portions 22, 24 are defined above and below an unthreaded, larger diameter, middle segment 26 of the stem 20. In this embodiment, the upper and lower portions 22, 24 of the stem 20 have opposing thread orientations, that is, right-handed and left-handed threads.

Referring now to FIG. 2, in this embodiment, stem 20 includes a rod 21 that is concentrically held inside the stem 20 and along a major portion of a length of the stem 20. Rod 21 is made from a more rigid material than the stem 20. In one embodiment, the rod 21 is made from a metallic material and the stem 20 is made from a polymeric material.

Still referring to FIG. 2, upper and lower collars 32, 34 have right-handed and left-handed threads and are threadedly mounted to the upper and lower portions 22, 24 of the stem 20. Each collar 32, 34 has three tabs 35 that extend from its outer circumferential surface. On each collar 32, 34, the tabs 35 are spaced radially from each other, by equal distances, about the perimeter of the collar 32, 34. Respective tabs 35 on the two collars 32, 34 are aligned with each other. Each tab 35 has a through-bore through which a bolt 38 extends that receives a nut 39 to part(s) a scissors link 50 to the tab 35 while allowing that part(s) to pivot about the bolt 38.

Still referring to FIG. 2, each of the scissors links 50 includes a firsts and a second arm which in this embodiment are shown as an upper arm 52 and a lower arm 55. Upper and lower arms 52, 55 are positioned and function as substantially mirror images of each other, as being reflected about a line extending radially from an outer surface of the middle segment 26 of the stem 20. Upper arm 52 has a first end 53 that is attached to tab 35 of the upper collar 32 with the bolt 38 and nut 39, so that the upper arm 52 can pivot about the bolt 38 and vary its orientation angle with respect to the stem 20. A second end 54 of upper arm 52 is pivotally attached to the pad 100, explained in greater detail elsewhere herein. Lower arm 55 has a first end 56 that is attached to tab 35 of the lower collar 34 with the bolt 38 and nut 39, so that the lower arm 55 can pivot about the bolt 38 and vary its orientation angle with respect to the stem 20. A second end 57 of lower arm 55 is pivotally attached to the pad 100.

Referring now to FIGS. 1, 3, and 4, a pivot 105 is defined at a joint that connects the second ends 54, 57 of the upper and lower arms 52, 55 and a tab 110 that extends from the pad 100 together, by way of a bolt 38 (FIG. 2) and nut 39 (FIG. 2). The tab 110 and thus the rest of the pad 100 can pivot about the bolt 38 which defines a pivot axis that is arranged orthogonally with respect to a longitudinal axis of the mount 10. This allows an upper end of the pad 100 to pivot about the pivot 105, toward and away from an upper end of the mount 10, and a lower end of the pad 100 pivot about the pivot 105, toward and away from a lower end of the mount 10. In this embodiment, tab 110 extends from the pad 100 at an upper portion of the pad 100, a height that is greater than a one-half height location of the pad 100, whereby the lower ends of pads 100 tend to pivot inwardly toward the stem 20 in a resting state, giving the mount 10 a resting state conical profile with a reduced diameter portion toward the bottom.

Referring again to FIG. 2, pad 100 further includes a plate 120, having a back surface from which the tab 110 extends. In this embodiment, plate 120 has a front surface with a perimeter ridge 125 that extends outwardly from the rest of the front surface. This embodiment also has multiple bumps 128 that extend outwardly from the front surface of the plate 120. The bumps 128 extend outwardly from the front surface of the plate 120 the same distance, optionally, less far than the perimeter ridge 125. In this embodiment, bumps 128 are spaced equidistantly from each other, about 7/32 inch, and have diameters of about 3/32 inch, plus or minus 10-percent. This provides the pad with an array of closely spaced discrete points that can engage and apply pressure to the cup holder 2, through an intervening cover 130.

Referring still to FIG. 2, pad 100 further includes cover 130 that fits inside of the perimeter ridge 125 and is adhered to the front surface of the plate 120. Cover 130 is made from a resilient material, for example, an elastomeric material-like rubber, which is more readily deformable than the plate 120 which is made from a more rigid and durable polymeric material.

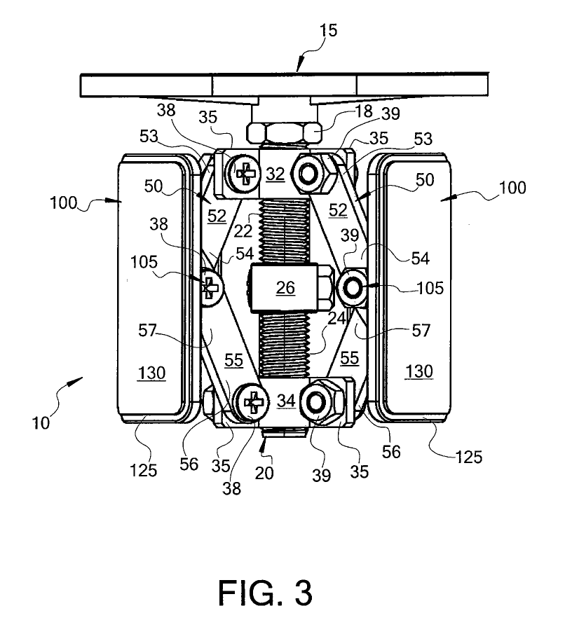

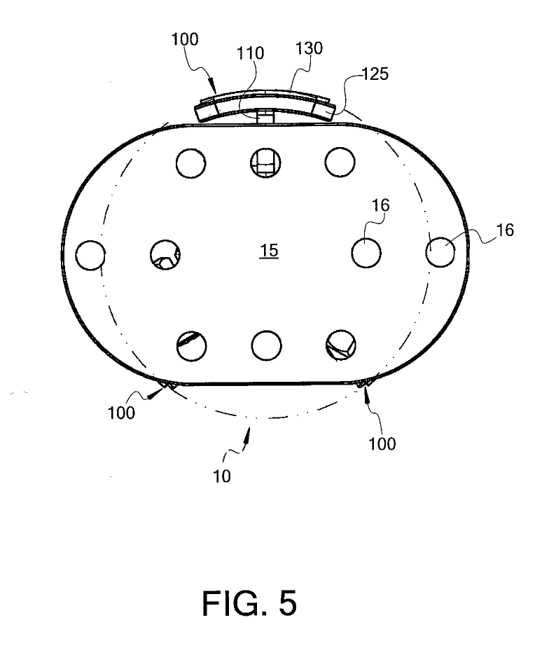

Referring now to FIGS. 1 and 3-6, to use the system 1, the user installs the mount 10 into the cup holder 2 (FIG. 1), without using any tools. If required, before inserting the mount 10 into the cup holder 2, the user draws the pads 100 toward the stem 20 to achieve the retracted pad 100 position(s) shown in FIGS. 3 and 5. In the retracted position(s), the diameter of a circle projected around the pads is about 2 and ⅝ inches, plus or minus 10-percent. This is done by rotating the plate 15 and thus also the stem 20 in a direction that forces the upper and lower collars 32, 34 to advance along the threaded upper and lower portions 22, 24 of the stem 20 away from each other and toward the respective ends of the stem 20. Moving the upper and lower collars 32, 34 away from each other pulls the first ends 53, 56 of the upper and lower arms 52, 55 away from each other, for each of the scissor links 50. This increases the angle between the second ends 54, 57 of the upper and lower arms 52, 55 and moves an outer portion of the scissors links 50, the pivots 105, and the pads 100 toward the stem 20.

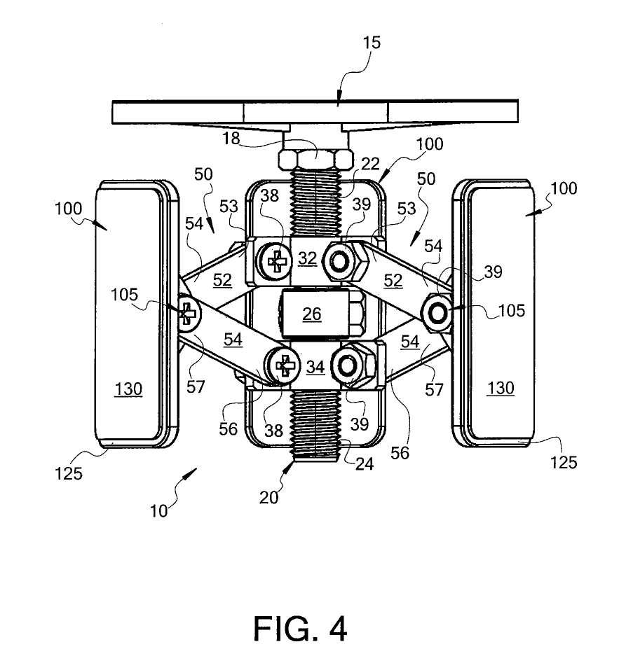

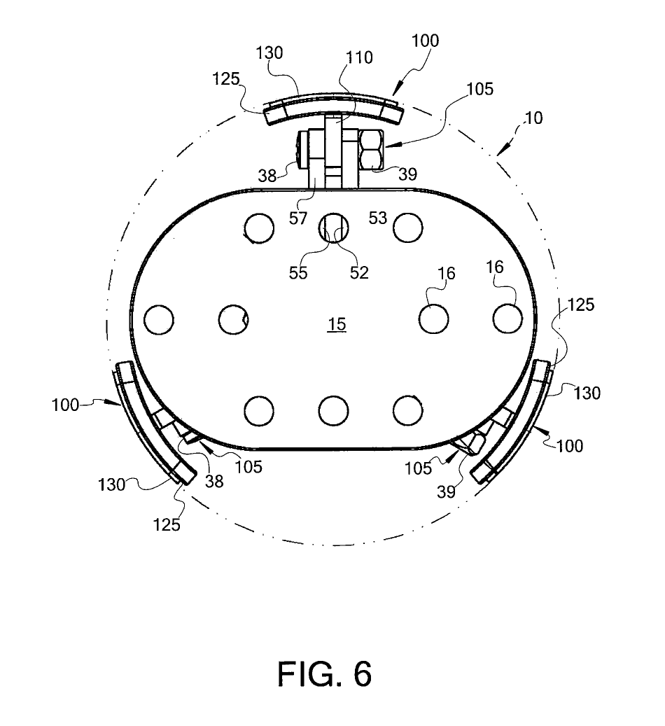

The user then insets the mount 10 into the cup holder 2. Is so doing, the pads 100 pivot about their respective pivots 105 so as to accommodate somewhat conical, tapered, or other non-perfect cylindrical configurations of the cup holder 2 and to instead conform to, for example, different diameters at different depths of the cup holder 2. When the mount 10 is suitably nested in the cup holder 2, the user pushes the pads 100 outwardly to achieve the extended pad position(s) shown in FIGS. 4 and 6 or positions that approach the extended position(s), until the mount 10 is firmly locked into the cup holder 2. In the extended position(s), the diameter of a circle projected around the pads is about 4 and ⅜ inches, plus or minus 10-percent. Moving the pads 100 to the extended position(s) is done in substantially the opposite way as that described above in the discussion of moving the pads 100 to the retracted position(s). The plate 15 and stem 20 are rotated in the opposite direction than that described above, so that the upper and lower collars 32, 34 regress along the threaded upper and lower portions 22, 24 of the stem 20, toward each other and toward the middle segment 26 of the stem 20. This moves the first ends 53, 56 of the upper and lower arms 52, 55 toward each other and decreases the angle between the second ends 54, 57 of the upper and lower arms 52, 55. Correspondingly, the outer portion of the scissors links 50, defined at the pivots 105, and the pads 100 move away from the stem 20, which pushes the pads 100 against the inner surface of the cup holder 2.

After the mount 10 has been installed in the cup holder 2, the accessory holder 5 is attached to the mount 10 using fasteners and/or other hardware, depending on the particular configuration(s) of the accessory holder 5 and the plate 15. The accessory 3 is then supported and held by the accessory holder 5. Removing the system 1 is done by performing such steps in the reverse order and using opposite operations, allowing the mount 10 or whole system to be installed in a cup holder 2 of a different vehicle or non-vehicle mounted cup holder 2.

While the foregoing written description of the invention enables one of ordinary skill to apply or use the system 1, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

Various alternatives are contemplated as being within the scope of the following claims particularly pointing out and distinctly claiming the subject matter regarded as the invention.

I hereby claim:

1. An accessory holder system for mounting to a cup holder comprising:
an accessory holder that can selectively hold an accessory;
a mount attached to the accessory holder and removably attaching the accessory holder to a cup holder, the mount including:
a scissors link having an outer portion that is transversely movable toward and away from a middle of the mount; and
a pad that is attached to and moves in unison with the outer portion of the scissors link for engaging and disengaging the cup holder.

2. The accessory holder system of claim 1, the mount further comprising a stem extending in a longitudinal direction, an upper collar connecting an upper arm of the scissors link to an upper portion of the stem, and a lower collar connecting a lower arm of the scissors link to a lower portion of the stem, wherein the upper and lower collars can move along the stem toward and away from each other so as to move the pad away from and toward the stem, respectively.

3. The accessory holder system of claim 2, wherein (i) the upper collar and upper portion of the stem have engaging threads that define a first thread orientation, and (ii) the lower collar and lower portion of the stem have engaging threads that define a second, opposite thread orientation, such that when the stem or collars are rotated in a first direction, the collars advance along the threads and move away from each other, and when the stem or collars are rotated in a second direction, the collars regress along the threads and move toward each other.

4. The accessory holder system of claim 1, the mount further comprising a plate at an upper end of the mount, the accessory holder being removably attached to the plate.

5. The accessory holder system of claim 4, further comprising a stem attached to the plate such that rotating the plate rotates the stem, and wherein rotating the stem moves the outer portion of the scissors link.

6. The accessory holder system of claim 4, further comprising a stem attached to the plate such that rotating the plate rotates the stem, and wherein rotating the stem moves the outer portion of the scissors link toward or away from the stem.

7. The accessory holder system of claim 1, further comprising a pivot that attaches the pad and the outer portion of the scissors link to each other.

8. The accessory holder system of claim 7, wherein the pivot defines a pivot axis that is orthogonal with respect to a length of the mount so that (i) an upper end of the pad can pivot toward and away from an upper end of the mount, and (ii) a lower end of the pad can pivot toward and away from a lower end of the mount.

9. The accessory holder system of claim 1, further comprising multiple scissor links that are spaced from each other about a perimeter of the mount, each of the scissor links having a pair of arms that have first ends that are spaced from each other and movable in a longitudinal direction with respect to the mount and second ends that attach to each other and the pad at the pivot, such that movement of the first ends of each of the pair of arms in the longitudinal direction is translated to movement of the second ends of each of the pair of arms in a transverse direction with respect to the mount.

10. The accessory holder system of claim 9, wherein the accessory holder is at least one of a cellular telephone holder, a global positioning system (GPS) device holder, a laptop computer holder, a food tray, a multiple drink holder, a writing pad holder, and a portable heater holder.

11. An accessory holder system for mounting to a cup holder comprising:
an accessory holder that can selectively hold an accessory; and
a mount attached to the accessory holder and that can insert into a cup holder for maintaining the accessory holder in a substantially constant position during use, the mount including:
a stem extending away from the accessory holder;
a pad that can engage the cup holder and is movable radially toward and away from the stem;
an arm interconnecting the stem and pad and having (i) a first end attached to the stem and that can move along at least part of a length of the stem, and (ii) a second end attached to the pad such that the second end moves the pad toward and away from the stem when the first end of the arm moves in opposing directions along the at least part of the length of the stem.

12. The accessory holder system of claim 11, further comprising a second arm having first and second ends that interconnect the stem and pad, the second arm cooperating with the first arm such that the first and second arms define a scissors link that translates movement of the first ends of the first and second arms along the length of the stem into transverse movement of an outer portion of the scissors link with respect to the stem.

13. The accessory holder system of claim 12, further comprising upper and lower collars that connect the first ends of the first and second arms to the stern while allowing movement of (i) the collars, and (ii) the first ends of the first and second arms, along the length of the stem.

14. The accessory holder system of claim 12, further comprising multiple pairs or first and second arms that interconnect multiple pads to the stem so as to permit the pads to move radially toward and away from the stem.

15. The accessory holder system of claim 14, further comprising a pivot that attaches each of the pads to the second ends of the respective first and second arms to each other and allows the pad to pivot with respect thereto, such that the multiple pivots allow the multiple pads to pivot so as to conform to a cup holder that has an inside diameter that differs at different portions of the cup holder.

16. The accessory holder system of claim 11, wherein the accessory holder is at least one of a cellular telephone holder, a global positioning system (GPS) device holder, a laptop computer holder, a food tray, a multiple drink holder, a writing pad holder, and a portable heater holder.
